(19) United States
(12) Patent Application Publication
(10) Pub. No.: US 2008/0176188 A1
(43) Pub. Date: Jul. 24, 2008

(54) METHOD OF DETECTING IMPLANTS

(75) Inventors: Stephan Holzner, Hohenschaftlarn (DE); Gerhard Weber, Purgen (DE)

Correspondence Address: DARBY & DARBY P.C., P.O. BOX 770, Church Street Station, New York, NY, 10008-0770, US

(73) Assignee: etkon Centrum fur dentale CAD/CAM-Technologie AG, Grafelfing (DE)

(21) Appl. No.: 11/936,197

(22) Filed: Nov. 7, 2007

(30) Foreign Application Priority Data
Nov. 7, 2006 (DE) 102006052419.5

(51) Int. Cl. A61C 19/04; A61C 3/00

(52) U.S. Cl. 433/215; 433/72

(57) ABSTRACT

The invention refers to a method of detecting implants in a jaw or an implant impression in a jaw impression, comprising the following steps: Inserting a gauging member into the implant or into the implant impression, scanning the jaw or the impression thereof together with the gauging member, detecting the position and orientation of the implant in the jaw or the jaw impression with the scan data obtained, wherein for detecting the position and orientation a set of data is used, which represents the individual shape of the gauging member. The invention further refers to a method of detecting the shape of a gauging member by scanning at least a portion that can be inserted into an implant or an implant impression, and of at least a second portion which can be scanned after insertion to determine the individual shape of the gauging member. The invention also refers to a gauging member for insertion into an implant and/or an impression thereof in combination with a set of data representing the individual shape of the gauging member or a set of data of such gauging members, as well as a further method and a computer-readable data carrier.

During manufacture of dental prosthesis parts or during the planning of dental treatments in which a prosthesis part is to be set onto an implant or an abutment of an implant, the problem regularly arises that the precise position of the implant is not known compared to the rest of the teeth or of the jaw.

To manufacture dental prosthesis member and for planning a dental treatment a cast, such as a plaster cast of a jaw is often made. This cast then has an implant impression in a jaw impression. An implant in a jaw or an implant impression in a jaw impression is usually difficult to detect since it is arranged deep in the jaw of the jaw impression on the internal side.

However, it is possible to insert gauging members into the implant or into the implant impression in a jaw impression and to optically or mechanically scan the jaw or the jaw impression together with the gauging member, and to infer from the detected position and orientation of the gauging member to the position and orientation of the implant in the jaw or in the jaw impression.

For this purpose, highly precisely manufactured gauging members are required to be capable of to determining the position and orientation of the implant in the jaw with the required precision.

However, the highly precise manufacture of this gauging member causes significant costs.

The object of the present invention is to enable the detection of implants or implant impressions at a high precision involving as few costs as possible.

This object is solved by a method of detecting implants according to claim 1, a method of identifying the shape of a gauging member according to claim 8, as well as a set of gauging members according to claim 15, a method according to claim 16 and a computer-readable data carrier according to claim 17.

A gauging member is used in the method which is usually not manufactured in a highly precise way. This leads to significant deviations of the shapes of different gauging members or to significant deviations from the predetermined target shape so that the gauging members have individual shapes that deviate from standard shapes.

To achieve a precise detection of implants or implant impression also with such gauging members, a set of data reproducing the individual shape of the gauging member is used for detecting the position and orientation.

Before carrying out such a method, a gauging member can for instance first of all be measured. The individual shape of the gauging member is determined thereby. This may for instance be implemented by scanning if this process delivers the required precision. The desired precision lies in the range of 5 μm, preferably 2 μm and even more preferably at 1 μm. That means that the real shape of the gauging member does not deviate by more than 5 μm, 2 μm, or 1 μm from the detected shape of the gauging member.

To determine the position and orientation of an implant, such a gauging member is inserted into the implant in a jaw or into the implant impression in a jaw impression and this combination is subsequently scanned.

Usually, the determination of position and orientation of the implant is carried out by means of a computer. A plurality of data sets of individual shapes of gauging members can be stored in such a computer. The user can also have the option of informing the computer which set of data is to be used, i.e. which gauging member was used during the scanning process.

Since all gauging members have slightly different dimensions and gauging members with fundamentally different shapes can be provided, it is also possible that the computer detects the data set by means of comparison with the data sets available stored on the computer that represents the individual shape of the gauging member in that the scan data obtained is compared to the stored sets of data.

It is also possible that two, three or four data sets are determined automatically, which most likely correspond to the data obtained during scanning, and that a user can then select which of these two, three or four sets of data represents the individual shape of the gauging member used.

The different gauging members can be provided with an identification, e.g. a number, letter or combination thereof to be able to easily distinguish the individual gauging members from one another.

Identifications of this type can also be detected during the scanning procedure so that a computer or a software on the computer identifies this identification to thereby determine the set of data to be used.

If more than one implant or implant impression exists in a jaw, a gauging member can subsequently be inserted into the different implants or implant impressions to determine the respective position and orientation of the implant or of the implant impression.

However, it is also possible that a plurality of gauging members are used simultaneously and are then scanned simultaneously or one after the other.

In a method of determining the shape of a gauging member, this member is scanned at least in a portion that can be inserted into an implant or an implant impression. Furthermore, a second portion is scanned, which can be scanned after inserting the gauging member into an implant or an implant impression, since this portion remained optically accessible. By this method the individual shape of the gauging member can be determined.

It is not required to know the entire shape of the gauging member, since it is sufficient to only know the part that is detected when scanning a gauging member inserted and the part that mechanically contacts the implant or the implant impression, since these are the two portions that are relevant to determine the position of the implant or the implant impression.

The gauging member to be inserted into an implant and/or an implant impression is provided together with a set of data, which represents the individual shape of the gauging member. Such a set of data can be provided in electronic form or on a data carrier or also by e-mail as a file on the internet or in a similar manner.

The gauging member has a part that can be inserted into an implant or an impression thereof, wherein this part can be rotational symmetrical or not rotational symmetrical.

In the case of a plurality of implants that are provided for attaching e.g. a bridge, it is advantageous if the implant with its upper form on which an abutment or the like is set on is rotational symmetrical in order not to geometrically over-define the dental treatment.

If, however, an implant is provided onto which merely one single dental prosthesis part, such as a crown or the like, is to be set on, it is advantageous if the implant is not rotational symmetrical in the respective portion to prevent distortion of the dental prosthesis part. It is then advantageous if the respective gauging member in the respective part is not rotational symmetrical.

The part of the gauging member that is to be scanned in the inserted condition, preferably comprises at least two, three, four, six, eight, ten or more planar surfaces. Such planar surfaces can easily be detected by means of software in scan data, particularly the edges between two planar surfaces. Spherical shapes or hemi-spherical shapes or different shapes, such as pyramidal cones, rings, grooves , sleeves or the like can also be used to give the gauging member an easily identifiable shape.

The gauging member can have an abutment, such as an abutment surface, which when inserting the gauging member abuts with the upper end of the implant to thereby define the position of the gauging member. This abutment is preferably provided at the transition between the part that is inserted into the implant and the part that is scanned in the inserted condition.

A set of different gauging members can comprise gauging members of the same type, i.e. for the same implants, which, however, are all slightly different for instance as a result of manufacturing tolerances. Different gauging members for the same implants can also be provided in one set, which, however, have fundamentally different shapes. A gauging member can for instance have a portion to be scanned with a hexagonal shape and another gauging member can have a triangular, quadrangular or pentagonal shape.

A set of gauging members can also comprise gauging members for different implants.

The position and orientation of a portion of the gauging member in a set of scan data is determined in a method. Furthermore, the position and orientation of an implant is determined in a set of scan data by using a set of data which represents the individual shape of the gauging member.

A computer program to carry out this method can be stored on a computer-readable data carrier.

Embodiments of the invention shall be explained by means of the enclosed Figures. Here shows:

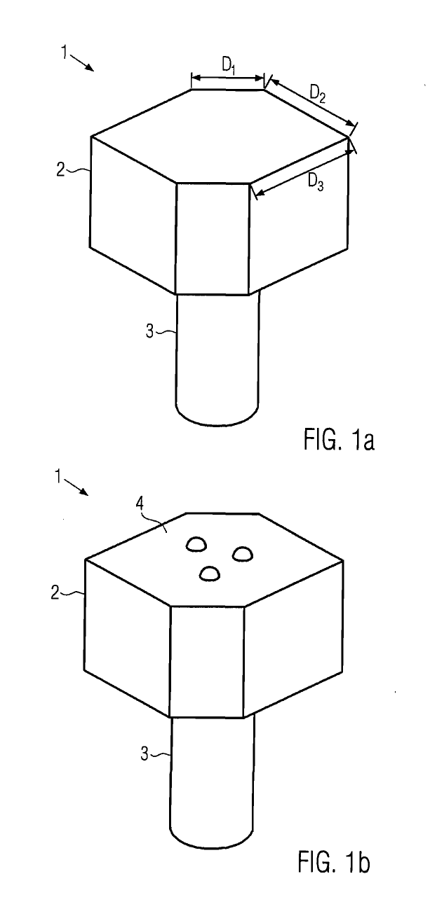

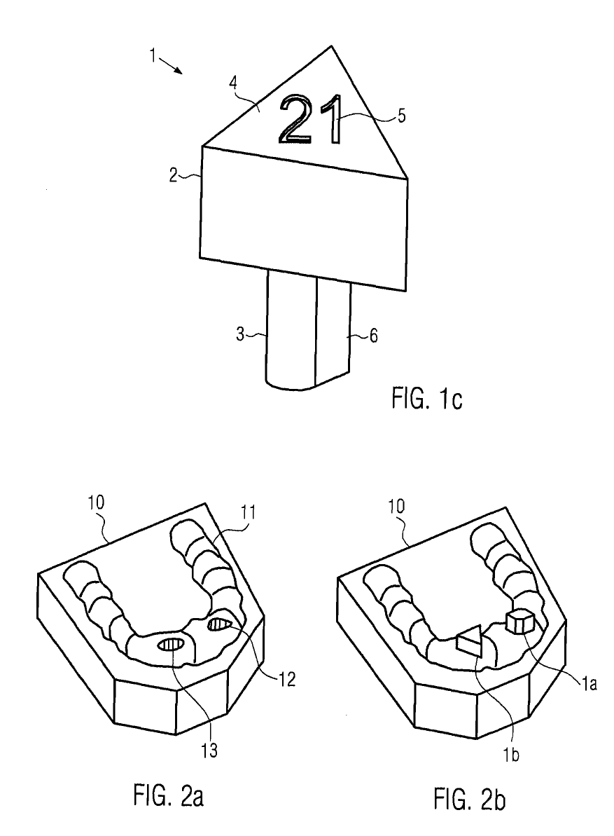

FIG. 1: different variants of gauging members;

FIG. 2: a jaw impression without a gauging member (FIG. 2a) and with gauging members inserted (FIG. 2b);

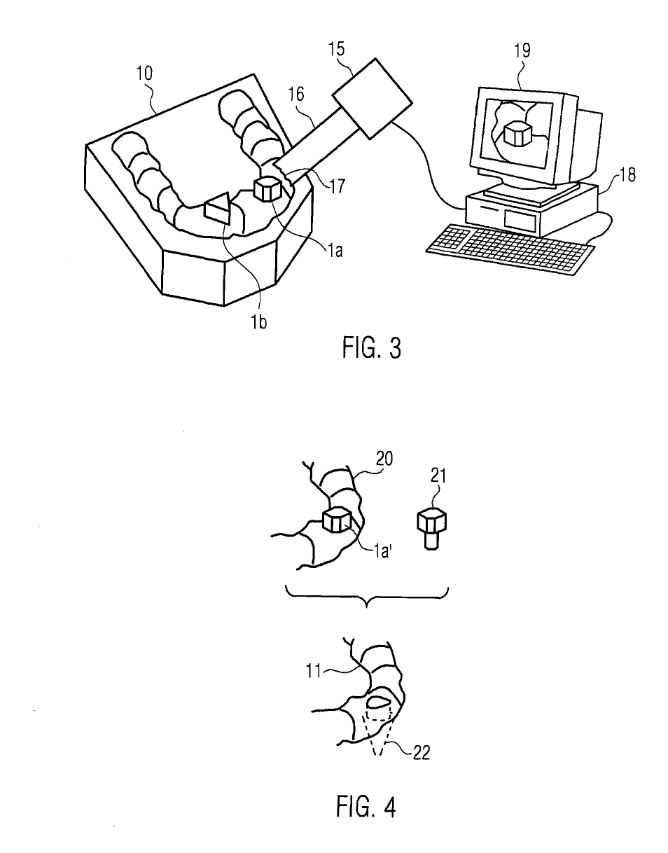

FIG. 3: a jaw impression together with a scanning device and a computer; and

FIG. 4: a schematic view of the detection of the position and orientation of an implant.

FIG. 1a shows a gauging member 1 with an upper hexagonal portion and a lower portion 3 in the shape of a round rod. The portion of a round rod shape 3 shall be inserted into an implant or an implant impression and the upper hexagonal portion 2 serves for scanning.

A gauging member in which e.g. the dimensions D1, D2 and D3, i.e. the sides of the hexagonal portion are exactly identically long or identically long with a precision of some μm, is very expensive.

In the gauging member shown in FIG. 1a, the dimensions D1, D2 and D3 are therefore not identically long but rather vary intentionally or as a result of manufacturing tolerances.

FIG. 1b shows a gauging member 1, in which hemi-spherical elements are shown additionally on the surface 4, said elements serving for position detection of the gauging member and/or for identifying the gauging member. Hemi-spherical shapes can well be detected during scanning and can well be evaluated by using the respective matching software to exactly determine the respective position of these 3 hemi-spheres (or also 1, 2, 4, 5 or more hemi-spheres).

The cross-sectional shape of the portion 2 does not have to be hexagonal. It can also be elliptical, circular, triangular, rectangular, lens-shaped, pentagonal, octagonal, polygonal or shaped irregularly in any other form.

FIG. 1c shows an example of a gauging member 1 which has a triangular cross section in portion 2.

The cross-sectional surface does not have to remain constant along the axis of the gauging member but the gauging member can also taper or broaden towards the top. For a scanning a tapering towards the top is to be preferred since the risk of turned-off portions, which cannot or hardly be scanned, is avoided.

The number 21 is engraved on the upper side 4 in FIG. 1c. It is provided in the form of a recess. However, it can also be provided in the form of an elevation.

The number 21 is representative for any alphanumeric or other (e.g. barcode) identification of the gauging member 1.

The advantage of such an alphanumeric identification is that on the one hand a user can easily identify the gauging member and can input a respective identification into a computer. On the other hand, such an identification can also directly be detected during a scanning process and be identified by a computer without a manual input being required.

FIG. 1c shows an additional detail, which, however, is independent of the shape of the portion 2 or the design of the surface 4.

FIG. 1c shows that the lower portion 3 can also not be rotational symmetrical (contrary to FIGS. 1a and 1b). In FIG. 1c this is provided by a flattening 6 of the rod 3.

All other shapes, as they are provided in implants, can be provided for the portion 3.

FIG. 2a shows a jaw impression 10 in the form of a model. The jaw is substantially toothless and only as a residual tooth portion 11.

Two openings 12 and 13 can be seen in the area 11, wherein implant impressions are located in these openings further downwards.

As can be seen in FIG. 2a, these implant impressions of FIG. 2a are optically hard to access so that the portion cannot or only hardly be identified by a simple scanning of the jaw impression 10.

FIG. 2b shows the same jaw impression 10 with two gauging members 1a, 1b inserted.

By scanning the combination of FIG. 2b, the position and orientation of the implants in the openings 12 and 13 can precisely be determined.

A respective scanning process or a respective scanning device is schematically shown in FIG. 3. The scanner in FIG. 2 is exemplarily an optical scanner 15. The optical scanner 15 can scan the surface of the jaw impression 10 in a line shape 17 by a scanning light beam 16. Other optical sensors or other mechanical scanning heads can also be used.

The data obtained by the scanner 15 is transmitted to a computer 18 and can there be displayed e.g. on a screen 19.

A set of data that represents the individual shape of the gauging member 1a, and a set of data, which represents the individual shape of the gauging member 1b, is stored in the computer 18.

It is schematically shown in FIG. 4 how a set of data 20 obtained by the scanner 15 and a set of data 21 stored on the computer 18, is joined to obtain a set of data representing the shape of the residual tooth portion 11 and which additionally defines the position and orientation of an implant 22. The position and orientation of the gauging member 1a is determined in the set of data 20, in that for instance the different planar surfaces of the hexagon are detected and the scan data obtained thereby is compared with the set of data 21 on the computer 18. By using for instance a matching method the set of data 21 can be integrated into the set of data 20. This leads to a relation between the set of data 20 and the part of the set of data 21 which corresponds to the second portion 3 of the gauging member 1a. From this information about the position of this second portion 3 it can be referred to the position of the respective implant 22.

It is shown in FIG. 3 that two different gauging members 1a, 1b are inserted simultaneously. However, it is also possible to first of all insert one gauging member 1 into the opening 12, to scan it and subsequently insert the same gauging member into the other opening 13 and to scan it again. The identification of position and orientation of the implant is also possible then.

The data detected during the different scanning processes can be combined on the computer 18 by a respective matching process to form larger sets of data. Thereby the relative position of the two implants of the openings 12 and 13 with respect to one another can be determined precisely.

1. Method of detecting implants in a jaw or a implant impression in a jaw impression, comprising the steps of:
inserting a gauging member into the implant or into the implant impression
scanning the jaw or the impression thereof together with the gauging member
detecting the position and orientation of the implant in the jaw or the jaw impression with the scan data obtained
wherein
a set of data representing the individual shape of the gauging member is used for determining the position and orientation.

2. Method as claimed in claim 1, wherein a gauging member is scanned independent of a jaw or a jaw impression at least in a portion that can be inserted into an implant or an implant impression, and at least in a portion which is scanned after insertion to determine the individual shape of the gauging member.

3. Method as claimed in claim 2, wherein the scanning is implemented in that the shape of the gauging member is determined at an accuracy of up to 5 μm.

4. Method as claimed in claim 1, wherein the determination of the position and orientation of the implant or the implant impression is carried out by a computer which is informed by a user which among a plurality of sets of data represents the individual shape of the gauging member.

5. Method as claimed in claim 1, wherein the determination of the position and orientation of the implant or the implant impression is carried out by a computer, wherein the computer is adapted such that by a comparison of the data obtained by scanning the jaw or the impression thereof together with the gauging member with the sets of data stored on the computer the set of data is determined that represents the individual shape of the gauging member.

6. Method as claimed in claim 1, wherein the steps of claim 1 are carried out successively for at least two implants or implant impressions.

7. Method as claimed in claim 1, wherein a plurality of gauging members are inserted simultaneously and are scanned.

8. Method for determining the shape of a gauging member by scanning at least one portion which can be inserted into an implant or an implant impression, and at least a second portion which can be scanned after insertion to determine the individual shape of the gauging member.

9. Gauging member for insertion into an implant and/or an impression thereof in combination with a set of data, which represents the individual shape of the gauging member.

10. Gauging member as claimed in claim 9, wherein the gauging member is rotationally symmetrical at least in the portion that can be inserted into an implant or an impression thereof.

11. Gauging member as claimed in claim 9, wherein the gauging member is not rotationally symmetrical in the portion that can be inserted into an implant or an impression thereof.

12. Gauging member as claimed in claim 9, wherein the gauging member comprises at least two planar surfaces.

13. Gauging member as claimed in claim 9, wherein the gauging member comprises at least one spherical shape or at least parts thereof, including a hemi-spherical shape.

14. Gauging member as claimed in claim 9, wherein the gauging member comprises an identification, wherein the identification is preferably given by the shape of the gauging member.

15. Set of different gauging members as claimed in claim 9.

16. Method, comprising the following steps:
determining the position and orientation of a portion of a gauging member in a set of scanning data, and
determining the position and orientation of an implant in the set of scanning data by using a set of data representing the individual shape of the gauging member.

17. Computer-readable data carrier with instructions for a computer for carrying out a method as claimed in claim 16.
